(19) United States
(12) Patent Application Publication
(10) Pub. No.: US 2005/0036560 A1
(43) Pub. Date: Feb. 17, 2005

(54) Cable calculator

(75) Inventors: William W. Lu, Irvine, CA (US); Mo-Ching Justine Lau, Orange, CA (US)

Correspondence Address: FOGG AND ASSOCIATES, LLC, P.O. BOX 581339, MINNEAPOLIS, MN, 55458-1339, US

(73) Assignee: ADC DSL Systems, Inc.

(21) Appl. No.: 10/640,747

(22) Filed: Aug. 14, 2003

(51) Int. Cl. H04L 25/00

(52) U.S. Cl. 375/257

(57) ABSTRACT

A method for modeling cable loss for a cable plant is provided. The method includes identifying a service to be provided over the cable plant, selectively entering a value corresponding to at least one parameter of the cable plant, and on entering values, determining and displaying the estimated cable loss for the cable plant providing the service based on the entered values and an empirical model of cable loss, the empirical model including data on losses affected by bridge tap placement and bridge tap length in the cable plant.

### BACKGROUND

Telecommunications networks evolve over time. A network designed to transport a given, initial service is often called on to carry other, more advanced services in later years. For example, telephone networks originally designed to carry narrowband voice traffic are now being called on to deliver high speed data transmissions. This natural evolution of telecommunications networks is driven by two competing factors. First, subscriber demand requires service providers to offer either a wider variety of services as new services are developed, or more advanced services, e.g., faster services, as existing services are improved. Second, installing a new network infrastructure to offer the more advanced services is typically cost prohibitive. Unfortunately, these more advanced services often have technical requirements that may not be met by an existing network infrastructure. Thus, not all networks will be able to carry all services.

The assignee of this application developed a tool to assist service providers in decisions regarding deployment of these more advanced services. This tool, known as the Cable Calculator, is a software program that allows a service provider to enter data related to its network, e.g., span length, cable type and gauge, operating environment (temperature), and the new service to be deployed on the network. Based on the entered data, the Cable Calculator estimates two criteria determinative of whether the service would work on the given network infrastructure. These criteria are cable loss and loop resistance. The Cable Calculator generates these estimates based on empirical data associated with the variables defining the network and service to be provided.

Unfortunately, prior generations of the cable calculator did not provide sufficiently accurate estimates for some newer, high speed services. It has been discovered that the cable loss and loop resistance, for some services, are affected in ways not considered in the earlier Cable Calculator releases. Therefore, there is a need in the art for an improved technique for modeling a cable plant to more accurately reflect the criteria for deployment of new, high speed services.

### SUMMARY

Embodiments of the present invention address problems with determining whether a network configuration will support a selected service. In one embodiment, a method for modeling cable loss for a cable plant is provided. The method includes identifying a service to be provided over the cable plant, selectively entering a value corresponding to at least one parameter of the cable plant, and on entering values, determining and displaying the estimated cable loss for the cable plant providing the service based on the entered values and an empirical model of cable loss, the empirical model including data on losses affected by bridge tap placement and bridge tap length in the cable plant.

### BRIEF DESCRIPTION OF THE DRAWINGS

FIG. 1 is one embodiment of a system for modeling a cable plant including bridge taps using empirical data including data associated with the location and length of the bridge taps.

FIG. 2 is a screen shot illustrating one embodiment of a portion of a graphical user interface for gathering values to model a cable plant.

FIG. 3 is a screen shot illustrating one embodiment of a graphical user interface for gathering values to model bridge taps in a cable plant.

FIGS. 4, 5, 6 and 7 are flow charts that illustrate embodiments of processes for determining cable loss for a cable plant.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

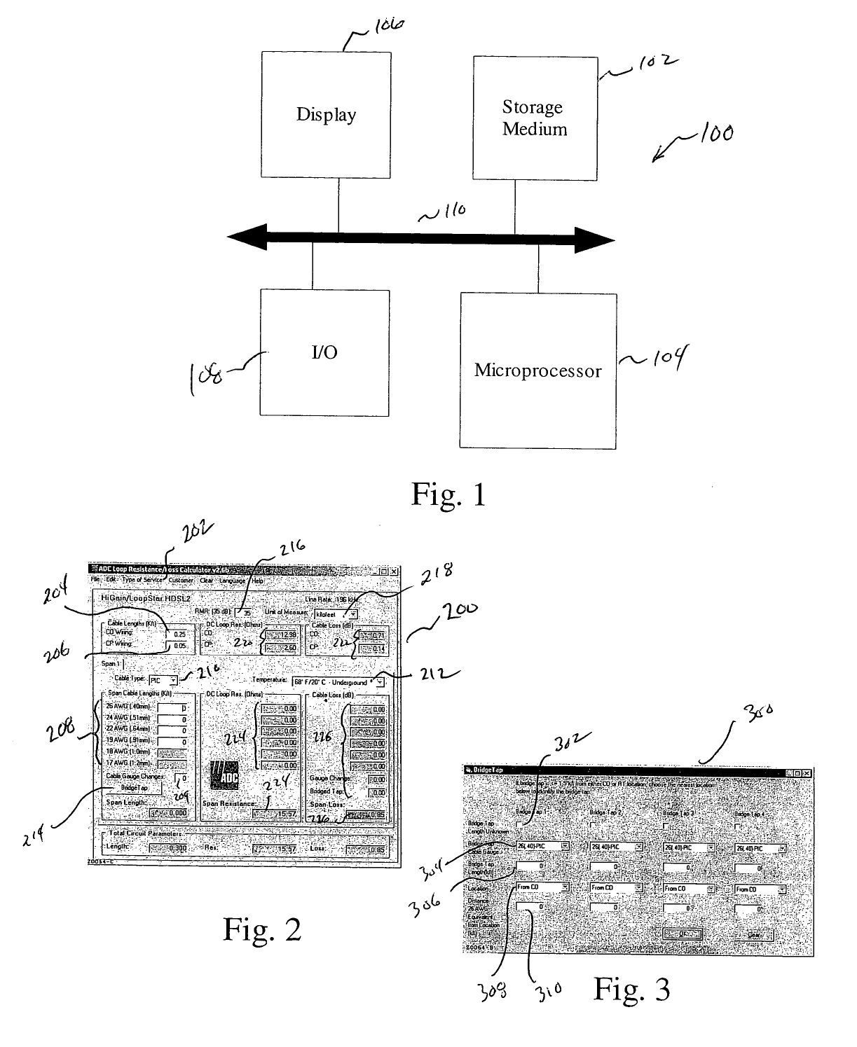

FIG. 1 is a block diagram of one embodiment of a system, indicated generally at 100, for modeling a cable plant including bridge taps using empirical data including data associated with the location and length of the bridge taps. In one embodiment, system 100 is a microprocessor based computer that is loaded with software embodied in machine readable instructions to allow system 100 to model the cable plant based on user inputs. The software accepts inputs as to values associated with parameters of the system, e.g., span lengths, cable type and gauge, operating conditions (temperature) and bridge tap location and length. With these values, the software estimates selected criteria associated with a selected service to be run on the cable plant.

System 100 stores the machine readable instructions of the software in storage medium 102 and executes these instructions in microprocessor 104. FIGS. 2-7 describe various aspects of embodiments of software storable in storage medium 102. In one embodiment, storage medium 102 includes one or more of the following: dynamic random access memory, static random access memory, magnetoresistive random access memory, electrical erasable programmable read only memory (EEPROM), erasable programmable read only memory (EPROM), Flash memory, compact disk, or other removable or fixed storage medium. Further, microprocessor 104 comprises at least one of a general purpose processor, special purpose processor, a programmable logic array, an application specific intergrated circuit (ASIC), or other appropriate device for executing machine readable instructions.

System 100 also includes display 106. Display 106 provides a graphical user interface for use in gathering user data and providing outputs from the software. System 100 includes input device 108 for gathering data from the user to define the characteristics of the cable plant and to select the service to be provided over the cable plant. In one embodiment, input device 108 comprises a keyboard, a mouse, a pointing device, a touch screen or any other appropriate input device or combination thereof. In one embodiment, display 106 and input 108 are combined in a single input/output device such as a touch screen or other appropriate input/output device. System 100 also includes bus 110 that provides a communication mechanism between storage medium 102, microprocessor 104, display 106 and input/output device 108.

In operation, system 100 estimates selected criteria associated with the potential offering of a service over a cable plant. System 100 executes instructions stored in storage medium 102. The user enters data or values through input device 108 for the parameters used by system 100 to create the estimates. The data relates to aspects of the cable plant. When sufficient data is available, the microprocessor 104 executes instructions stored in storage medium 102 to display or update the current values for the selected criteria associated with the selected service. These values are displayed at display 106. This process is repeated as data values are entered by the user until the user is finished with entering data to characterize the cable plant. At any point that the estimated values exceed the recommended levels for the selected criteria, the microprocessor causes warning messages to be displayed on display 106 based on instructions in storage medium 102.

FIGS. 2 and 3 illustrate screen shots of embodiments of a graphical user interface for gathering values for modeling the cable plant. In one embodiment, the screens shown in FIGS. 2 and 3 are used with the system of FIG. 1 and are displayed on display 106 to allow the user to enter data and receive feedback from system 100.

Screen 200 of FIG. 2 allows the entry of values that specify the service to be provided over the modeled cable plant. Specifically, screen 200 includes a pull down menu 202 labeled “Type of Service.” This pull down menu includes a list of the types of services that are included in the empirical data of the modeling software. For example, in one embodiment, this list includes services such as service provided according to ANSI T1.418 HDSL2 standard Overlapping Pulse Amplitude Modulation with Interlocking Spectra (OPITS), High-bit-rate Digital Subscriber Line Two (HDSL2), and service offered according to ANSI T1.418-2002 HDSL4 standard High-bit-rate Digital Subscriber Line Four (HDSL4). Further, screen 200 includes field 216 that receives a threshold value that defines an acceptable range for at least one of the criteria for offering the service over the cable plant. In one example, field 216 receives a threshold value for cable loss for acceptable performance for the selected service. This value is user definable but is typically specified for the service.

Screen 200 also provides a number of fields to allow the user to input values for various parameters of the cable plant to be modeled. First, screen 200 includes fields for receiving values for cable lengths for the central office (CO) and customer premises (CP) wiring. Field 204 accepts a value (in a unit of measure, e.g., kilofeet, as specified in field 218) for the length of the CO wiring. Field 206 accepts a value (in kilofeet) for the length of the CP wiring.

Screen 200 also includes fields to accept values related to the cable length. Fields 208 accept values for the length of cable spans of various gauges. For example, in one embodiment, fields 208 include fields associated with cable gauges of 17, 18, 19, 22, 24, and 26 AWG. Field 209 accepts a value indicating the number of gauge changes in the span. Further, screen 200 includes pick list 210 for defining the type of cable, e.g., plastic-insulated cable (PIC) or paper-insulated cable (PULP).

Screen 200 includes another pick list 212 for specifying the operating condition, e.g., temperature, of the cable plant. In one embodiment, pick list 212 includes three options: 68° F./20° C.—underground; 90° F./32° C.—buried; 120° F./50° C. aerial.

Finally, screen 200 includes a button 214 for defining the location and length of bridge taps associated with the span. One embodiment of a screen for gathering values for the bridge taps is described below with respect to FIG. 3.

Screen 200 also provides output values to the user. For example, fields 220 and 222 provide DC loop resistance and cable loss values, respectively, based on calculations performed by the software. These values are updated when sufficient input values are available. Further, fields 224 and 226 provide DC loop resistance and cable loss for each span, respectively.

FIG. 3 is a screen shot, indicated generally at 30, illustrating one embodiment of a graphical user interface for gathering values to model bridge taps in a cable plant. In one embodiment, screen 300 allows specification of values to define up to four bridge taps. In other embodiments, other appropriate number of bridge taps may be specified.

For each bridge tap, screen 300 includes five inputs to define the bridge tap. First, screen 300 provide check box 302 to indicate that the location of the bridge tap is unknown. When unknown, the effect of the bridge tap is estimated to be 3 dB in cable loss. Screen 300 also provides field 304 (cable gauge) and field 306 (length) define the cable used in the bridge tap. Further, screen 300 also provides fields 308 and 310 for defining the position of the bridge tap. Field 308 is a pick list that defines the location from which the distance is measured, e.g., from the CO or CP. Second, field 310 receives a value that defines the distance that the bridge tap is located from the location selected in field 308.

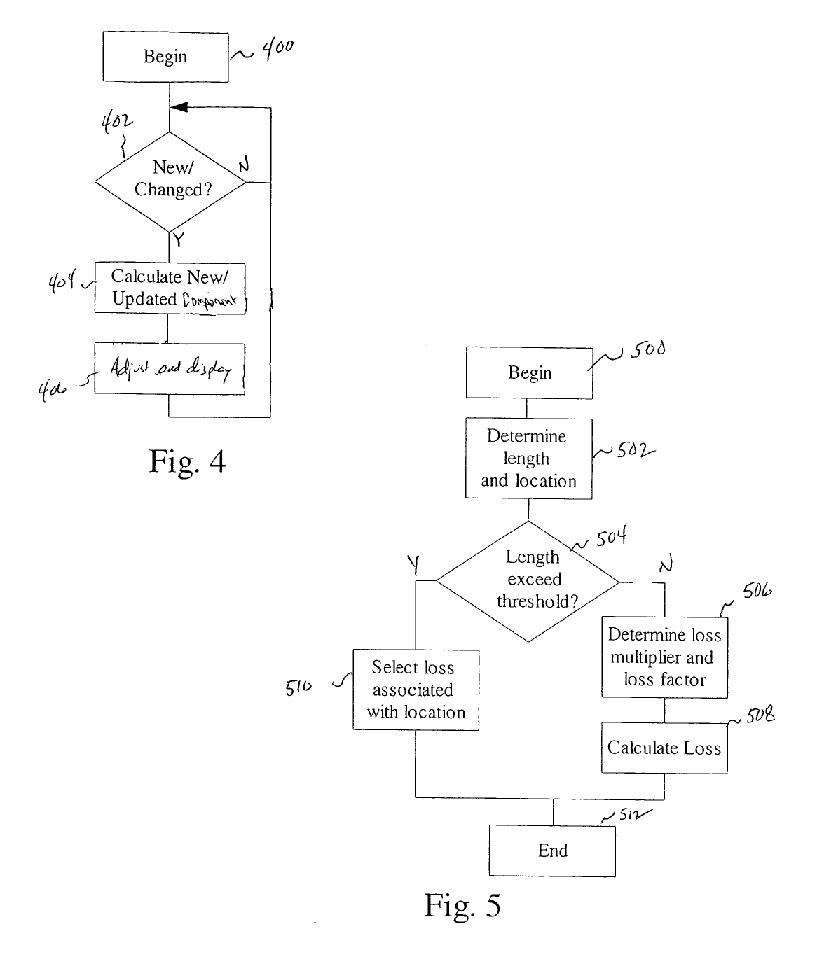

FIGS. 4, 5, 6, and 7 are flow charts that illustrate embodiments of processes for determining cable loss for a cable plant. FIG. 4 provides an overview of one embodiment of a process for updating the estimate of the cable loss based on the new or changed values entered into the system, e.g., system 100 of FIG. 1. The process of FIG. 4 begins at block 400. At block 402, the process determines whether a new or changed value has been received. If not, the process returns to block 402. If a new or changed value has been received, the process proceeds to block 404 and calculates a new or updated component of the estimate based on the newly entered or updated value. For example, in one embodiment, the estimate of the cable loss is based on three components: span loss, bridge tap loss, and gauge change loss. In other embodiments, other components are used to determine an overall cable loss estimate. At block 406, the process adjusts the estimate based on the new or updated component and updates the display. The method returns to block 402 to wait for another new or updated value to be entered.

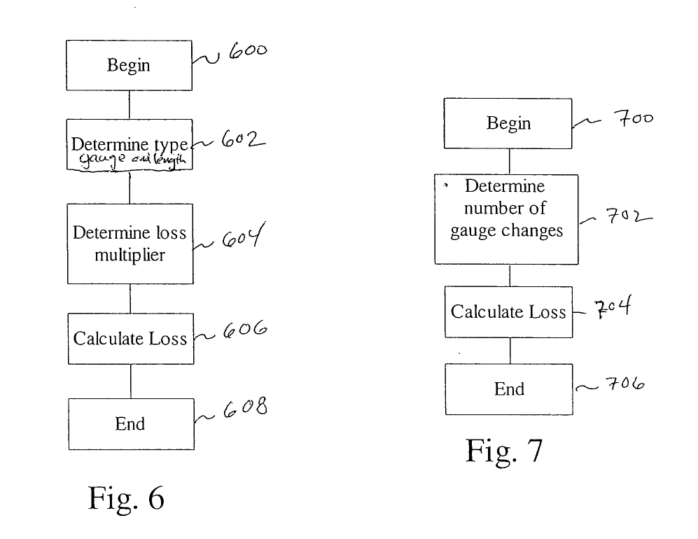

FIGS. 5, 6, and 7 illustrate embodiments of processes for generating components of the estimate. Specifically, FIG. 5 is a flow chart that illustrates one embodiment of a process for determining a loss component due to bridge taps in the cable plant. FIG. 6 is a flow chart that illustrates one embodiment of a process for determining a span loss component due to the cable spans in the cable plant. Finally, FIG. 7 is a flow chart that illustrates one embodiment of a process for determining a loss component due to the number of gauge changes in the cable plant.

The process of FIG. 5 begins at block 500. At block 502, the process determines the length and location of the bridge tap from values entered into the system by the user. One factor that determines the cable loss associated with the bridge tap is the length of the span associated with the bridge tap. At block 504, the process tests the length of the span associated with the bridge tap against a threshold. Depending on the value of the length relative to the threshold, different formulas are used to determine the component of the cable loss contributed by the bridge tap. Each case is described in turn below.

When the length of the cable span associated with the bridge tap is less than the threshold, then the process determines a loss multiplier and loss factor, e.g., from table look-ups at block 506. The loss multiplier is based on values entered for cable type, operating conditions (temperature), selected service and cable gauge. In one embodiment, the loss multiplier is selected according to the following table for HDSL2 service. In Table 1, the loss multiplier is shown for PIC cables in dB/kft at 196 kHz and 135 Ω terminal resistance.

TABLE 1

| Temperature | 26 AWG | 24 AWG | 22 AWG | 19 AWG |
|---|---|---|---|---|
| 68° F./20° C. | 3.88 | 2.84 | 2.18 | 1.54 |
| 90° F./32° C. | 4.03 | 2.94 | 2.23 | 1.57 |
| 120° F./50° C. | 4.23 | 3.06 | 2.31 | 1.62 |

Table 2 shows the loss multiplier for PULP cables in dB/kft at 196 kHz and 135 Ω terminal resistance.

TABLE 2

| | 26 | 24 | 22 | 19 | 18 | 17 |
|---|---|---|---|---|---|---|
| Temperature | AWG | AWG | AWG | AWG | AWG | AWG |
| 68° F./20° C. | 4.01 | 3.13 | 2.46 | 1.80 | 1.12 | .885 |
| 90° F./32° C. | 4.15 | 3.30 | 2.52 | 1.84 | 1.13 | .904 |
| 120° F./50° C. | 4.36 | 3.36 | 2.61 | 1.89 | 1.18 | .931 |

The loss factor is selected, in one embodiment, based on the location of the bridge tap and the selected service. For example, when the selected service is HDSL2, the loss factor is selected according to the following Table 3:

TABLE 3

| Bridge tap location (BT) | Loss Mulitplier |
|---|---|
| BT ≦ 0.5 Kft from the closest terminal | 1.5 |
| 0.5 < BT ≦ 1.5 Kft from the closest terminal | 1.0 |
| BT > 1.5 Kft from the closest terminal | 0.0 |

Further, for HDSL4, the loss factor is selected according to the following Table 4 based on different thresholds:

TABLE 4

| Bridge tap location (BT) | Loss Mulitplier |
|---|---|
| BT ≦ 1 Kft from closest terminal | 1.5 |
| 1 < BT ≦ 2 Kft from the closest terminal | 1.25 |
| 2 < BT ≦ 3 Kft from the closest terminal | 1.0 |
| BT > 3 Kft from the closest terminal | 0.0 |

At block 508, the loss component associated with the bridge tap is calculated. The loss component is equal to the product of the length of the bridge tap, the loss multiplier, and the loss factor. The process ends at block 512.

At block 504, when the length does exceed the threshold, the process proceeds to block 510. At block block 510, the process selects the loss for the bridge tap based on the location of the bridge tap and the selected service. Table 5 below provides the loss associated with provision of HDSL2 service.

TABLE 5

| Bridge tap location (BT) | Bridge Tap Loss |
|---|---|
| BT ≦ 0.5 Kft from the closest terminal | 3.0 |
| 0.5 < BT ≦ 1.5 Kft from the closest terminal | 2.0 |
| BT > 1.5 Kft from the closest terminal | 0.0 |

Table 6 provides the loss associated with provision of HDSL4 service.

TABLE 6

| Bridge tap location | Loss |
|---|---|
| BT ≦ 1 Kft from closest terminal | 4.0 |
| 1 < BT ≦ 2 Kft from the closest terminal | 3.3 |
| 2 < BT ≦ 3 Kft from the closest terminal | 2.6 |
| BT > 3 Kft from the closest terminal | 0.0 |

The value from either table 5 or table 6 provides the loss component for the bridge tap without any further multiplication or modification. The process ends at block 512.

As discussed above, FIG. 6 is a flow chart that illustrates one embodiment of a process for determining a span loss component due to the cable spans in the cable plant. The factors involved in this calculation are the type, gauge and length of the cable, as well as a loss multiplier. The loss multiplier varies with gauge and operating environment (temperature). The method begins at block 600. At block 602, the method determines the type, gauge and length of the cable. At block 604, the method determines the loss multiplier, e.g., through a table look up. Tables 7 and 8 below show the loss multiplier for PIC and PULP cables respectively.

TABLE 7
PIC Cable

| Temperature | 26 AWG | 24 AWG | 22 AWG | 19 AWG |
|---|---|---|---|---|
| 68° F./20° C. | 3.88 | 2.84 | 2.18 | 1.54 |
| 90° F./32° C. | 4.03 | 2.94 | 2.23 | 1.57 |
| 120° F./50° C. | 4.23 | 3.06 | 2.31 | 1.62 |

TABLE 8
PULP Cable

| | 26 | 24 | 22 | 19 | 18 | 17 |
|---|---|---|---|---|---|---|
| Temperature | AWG | AWG | AWG | AWG | AWG | AWG |
| 68° F./20° C. | 4.01 | 3.13 | 2.46 | 1.80 | 1.12 | .885 |
| 90° F./32° C. | 4.15 | 3.30 | 2.52 | 1.84 | 1.13 | .904 |
| 120° F./50° C. | 4.36 | 3.36 | 2.61 | 1.89 | 1.18 | .931 |

For HDSL4 service, the loss multipliers is also selected according to the same Tables 7 and 8 based on the cable gauge and operating condition.

At block 606, the loss component is calculated by multiplying the length of the span by the loss multiplier. This produces a loss component in decibels (dB) that is added to other loss components, e.g., under the process of FIG. 4, to determine the total loss for the cable plant. The process ends at block 608.

As mentioned above, FIG. 7 is a flow chart that illustrates one embodiment of a process for determining a loss component due to the number of gauge changes in the cable plant. This process begins at block 700 and determines the number of gauge changes at block 702. At block 704, the process calculates the loss component due to gauge changes as the 1 dB per gauge change. This loss component is added with other loss components, e.g., using the process of FIG. 4, to determine the overall loss. The process ends at block 706.

Although the processes of FIGS. 4-7 are described in terms of calculating the estimates based on the user inputs, it is understood that look-up tables and other data structures can be used in place of various calculations described above.

The following two numerical examples are provided to aid in the understanding of the operation of the processes of FIGS. 4-7. In the first example, the following values are applied to the software program to determine the overall cable loss for HDSL2 service:

| Parameter | User Input |
|---|---|
| Cable Type (Field 210) | PIC |
| Temperature (Field 212) | 68 F./20 C. Underground |
| CO Wiring (Field 204) | 0.25 kft |
| CP Wiring (Field 206) | 0.05 kft |
| Span Cable Length (Field 208) | 26 AWG (0.40 mm): 5 kft |
| | 24 AWG (0.51 mm): 3 kft |
| Cable Gauge Changes (Field 209) | 1 |
| Bridge Tap Cable Gauge (Field 304) | 26(.40)-PIC |
| Bridge Tap Length (Field 306) | 1 kft |
| Bridge Tap Location (Field 308) | From CO |
| Distance 26 AWG Equivalent from | 0.5 kft |
| Location (Field 310) | |

Using the process of FIG. 5, the bridge tap loss is calculated as follows. First, at block 502, the process determines the length and location of the cable span associated with the bridge tap based on the user input as 1 kft in length located 0.5 kft from the CO. At block 504, the process applies the 1 kft length against the threshold of 0.6 kft and proceeds from block 504 to block 510. At block 510, the process determines the appropriate loss component based on the location of the bridge tap according to Table 5. Thus, this loss component is 3.0 dB due to its placement of 0.5 kft from the CO.

Using the process of FIG. 6, the loss component due to the cable span is calculated. At block 602 the process determines that there are 5 kft of 26 AWG PIC cable and 3.3 kft of 24 AWG PIC cable. The process determines the appropriate multipliers at block 604 using table 7. For the 26 gauge cable, the multiplier is 3.88 and the multiplier for the 24 gauge cable is 2.84. At block 606, the cable losses are calculated as 19.4 dB for the 26 gauge cable and 9.372 for the 24 gauge cable.

Applying the process of FIG. 7, the process determines that one gauge change produces a 1 dB loss. Finally, the total loss is determined in FIG. 4 by adding the loss components from each of the calculations produced by the processes of FIGS. 5, 6, and 7. This produces a loss value of 32.77 dB (which is displayed in the green color that indicates this is a valid network configuration since the acceptable loss level is 35 dB.)

In a second example, the user provides the following inputs for a cable plant using HDSL2 service:

| Parameter | User Input |
|---|---|
| Cable Type (Field 210) | PIC |
| Temperature (Field 212) | 68 F./20 C. Underground |
| CO Wiring (Field 204) | 0.25 kft |
| CP Wiring (Field 206) | 0.05 kft |
| Span Cable Length (Field 208) | 26 AWG (0.40 mm): 7 kft; |
| | 24 AWG (0.51 mm): 3 kft |
| Cable Gauge Changes (Field 209) | 3 |
| Bridge Tap Cable Gauge (Field 304) | 26(.40)-PIC |
| Bridge Tap Length (Field 306) | 1 kft |
| Bridge Tap Location (Field 308) | From CO |
| Distance 26 AWG Equivalent from | 0.5 kft |
| Location (Field 310) | |

Using the process of FIGS. 4-7, this produces a total estimated loss of 42.53 dB (which is displayed in the red color that alerts user this configuration exceeds the recommended loop insertion loss.) In addition, the following red warning message pops up on the screen: “Loop plus bridge tap is greater than 9 kft”

Those skilled in the art will recognize that the techniques and methods described here are implemented, in some embodiment, by programming a programmable processor with appropriate instructions to implement the functionality described here. In such embodiments, such program instructions are stored in a suitable memory device (for example, read-only memory and/or random-access memory) from which the program instructions are retrieved during execution. Also, suitable data structures are stored in memory in such embodiments.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A method for modeling cable loss for a cable plant, the method comprising:
identifying a service to be provided over the cable plant;
selectively entering a value corresponding to at least one parameter of the cable plant; and
on entering values, determining and displaying the estimated cable loss for the cable plant providing the service based on the entered values and an empirical model of cable loss, the empirical model including data on losses affected by bridge tap placement and bridge tap length in the cable plant.

2. The method of claim 1, wherein determining the estimated cable loss comprises calculating the cable loss based on the entered values.

3. The method of claim 1, wherein displaying the estimated cable loss comprises comparing the estimated cable loss with a threshold value and using a first color when displaying the estimated cable loss above the threshold and a second color when displaying the estimated cable loss below the threshold.

4. The method of claim 1, wherein determining the estimated cable loss comprises:
calculating a first cable loss based on cable gage and cable length for each span;
calculating a second cable loss associated with at least one bridge tap based on at least one of bridge tap placement and length;
calculating a third cable loss associated with changes in gage between cables in the cable plant; and
adding the first, second and third cable losses.

5. The method of claim 4, wherein calculating the second cable loss comprises:
determining entered length and placement values for the bridge tap; and
calculating the second cable loss using a formula based on at least one of length and placement of the bridge tap.

6. The method of claim 4, wherein calculating the second cable loss comprises:
for bridge taps of greater than a selected length, calculating a cable loss based solely on the position of the bridge tap; and
for bridge taps less than the selected length, calculating a cable loss based on the location and length of the bridge tap.

7. The method of claim 4, wherein calculating the second cable loss comprises assigning a fixed cable loss for a bridge tap of unknown position.

8. The method of claim 4, wherein calculating the third cable loss comprises assigning a cable loss value equal to the number of gage changes times a selected cable loss.

9. A method for modeling cable loss for a cable plant, the method comprising:
identifying a service to be provided over the cable plant;
selectively entering a first set of values corresponding to the cable spans of the cable plant;
selectively entering a second set of values corresponding to the bridge taps of the cable plant; and
on entering each one of the first and second set of values, calculating component loss values for one of the cable spans and the bridge taps;
combining the component loss values for the cable spans and the bridge taps to generate an estimated cable loss; and
displaying the estimated cable loss for the cable plant providing the service based on the entered values and an empirical model of cable loss, the empirical model including data on losses affected by bridge tap placement and bridge tap length in the cable plant.

10. The method of claim 9, wherein identifying a service comprises identifying at least one of HDSL2 and HDSL4.

11. The method of claim 9, wherein displaying the estimated cable loss comprises displaying the estimated cable loss on the same screen of a graphical user interface used to selectively enter at least some of the first and second set of values.

12. The method of claim 9, wherein calculating the component loss value for the bridge tap comprises selecting a formula based on the length of the bridge tap.

13. A tool for modeling cable loss for a cable plant, the tool comprising:
means for identifying a service to be provided over the cable plant;
means for selectively entering a value corresponding to at least one parameter of the cable plant; and
means, communicatively coupled to the means for identifying and means for selectively entering, for determining and displaying the estimated cable loss for the cable plant providing the service on entry of the values based on the entered values and an empirical model of cable loss, the empirical model including data on losses affected by bridge tap placement and bridge tap length in the cable plant.

14. A tool for modeling cable loss for a cable plant, the tool comprising:
means for identifying a service to be provided over the cable plant;
means for selectively entering a first set of values corresponding to the cable spans of the cable plant;
means for selectively entering a second set of values corresponding to the bridge taps of the cable plant; and
means, communicatively coupled to the means for identifying and the means for selectively entering the first set of values and the means for selectively entering the second set of values, for calculating component loss values for one of the cable spans and the bridge taps on entering each one of the first and second set of values;
means, communicatively coupled to the means for calculating, for combining the component loss values for the cable spans and the bridge taps to generate an estimated cable loss; and
means, communicatively coupled to the means for combining, for displaying the estimated cable loss for the cable plant providing the service based on the entered values and an empirical model of cable loss, the empirical model including data on losses affected by bridge tap placement and bridge tap length in the cable plant.

15. A machine readable medium having instructions stored thereon for implementing a method for modeling cable loss for a cable plant, the method comprising:
identifying a service to be provided over the cable plant;
selectively entering a value corresponding to at least one parameter of the cable plant; and
on entering values, determining and displaying the estimated cable loss for the cable plant providing the service based on the entered values and an empirical model of cable loss, the empirical model including data on losses affected by bridge tap placement and bridge tap length in the cable plant.

16. The machine readable medium of claim 15, wherein determining the estimated cable loss comprises calculating the cable loss based on the entered values.

17. The machine readable medium of claim 15, wherein displaying the estimated cable loss comprises comparing the estimated cable loss with a threshold value and using a first color when displaying the estimated cable loss above the threshold and a second color when displaying the estimated cable loss below the threshold.

18. The machine readable medium of claim 15, wherein determining the estimated cable loss comprises:
calculating a first cable loss based on cable gage and cable length for each span;
calculating a second cable loss associated with at least one bridge tap based on at least one of bridge tap placement and length;
calculating a third cable loss associated with changes in gage between cables in the cable plant; and
adding the first, second and third cable losses.

19. The machine readable medium of claim 18, wherein calculating the second cable loss comprises:
determining entered length and placement values for the bridge tap; and
calculating the second cable loss using a formula based on at least one of length and placement of the bridge tap.

20. The machine readable medium of claim 18, wherein calculating the second cable loss comprises:
for bridge taps of greater than a selected length, calculating a cable loss based solely on the position of the bridge tap; and
for bridge taps less than the selected length, calculating a cable loss based on the location and length of the bridge tap.

21. The machine readable medium of claim 18, wherein calculating the second cable loss comprises assigning a fixed cable loss for a bridge tap of unknown position.

22. The machine readable medium of claim 18, wherein calculating the third cable loss comprises assigning a cable loss value equal to the number of gage changes times a selected cable loss.
